(19) United States
(12) Patent Application Publication
(10) Pub. No.: US 2009/0055226 A1
(43) Pub. Date: Feb. 26, 2009

(54) METHOD AND SYSTEM FOR DETERMINING RATES OF INSURANCE

(75) Inventors: Joe TRITZ, Custer, WI (US); Kristina Smith, Stevens Point, WI (US); Jason Schilling, Berlin, WI (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: American International Group, Inc., New York, NY (US)

(21) Appl. No.: 12/195,231

(22) Filed: Aug. 20, 2008

Related U.S. Application Data
(60) Provisional application No. 60/956,865, filed on Aug. 20, 2007.

(51) Int. Cl. G06Q 40/00; G06F 17/00; G06Q 90/00

(52) U.S. Cl. 705/4; 705/400

(57) ABSTRACT

The invention provides a method and system for determining rates of insurance for travelers based on certain risk parameters. Insurance rates are computed using factor relativities derived from insured data and parameters for several different insurance coverages. Factor relativities are computed through an iterative process using a minimum bias procedure according to each coverage. Parameters are evaluated simultaneously for each coverage to eliminate cross bias from one parameter to another. Once factor relativities are calculated, the system and method allows for a consumer to request a rate on an insurance coverage. The system and method provides the rate using the factor relativities for the requested coverage. The method and system also provides insurance rates to additional or upgraded insurance coverages based on consumer preferences.

### CROSS-REFERENCE TO RELATED APPLICATIONS

This patent application claims the benefit of U.S. Provisional Patent Application No. 60/956,865, filed Aug. 20, 2007, which is incorporated by reference.

### FIELD OF THE INVENTION

The invention generally relates to a method and system for determining rates for insurance. More particularly, the invention relates to a method and system for determining base insurance rates using multiple risk parameters and factors.

### SUMMARY OF THE INVENTION

Insurance rates are computed using factors derived from insured data and parameters for several different insurance coverages. Factors are computed through an iterative process using a minimum bias procedure according to each coverage. Parameters are evaluated simultaneously for each coverage to eliminate cross bias from one parameter to another. Once factor relativities are calculated, the system and method calculates a rate on an insurance coverage using the factors for the requested coverage. The method and system also provides insurance rates for additional or upgraded insurance coverages based on consumer preferences. The underwriting methodology as described in detail below provides unexpected results. By isolating individual factors and eliminating cross biases, a more accurate rate may be established.

### BRIEF DESCRIPTION OF THE DRAWINGS

FIG. 1 is a diagram illustrating an exemplary system for calculating and issuing insurance rates;

FIG. 2 is a diagram illustrating an exemplary method for determining multi-factor based insurance rates using a minimum bias approach;

FIG. 3 is a diagram illustrating an exemplary method employed by a multi-factor based insurance system.

FIG. 4 is a table listing exemplary parameter bands and seed factors for an Age parameter;

FIG. 5 is a table listing exemplary parameter bands and seed factors for a Trip Cost parameter;

FIG. 6 is a table listing exemplary parameter bands and seed factors for a Trip Length parameter;

FIG. 7 is a table listing exemplary parameter bands and seed factors for a Destination parameter;

FIG. 8 is a table listing exemplary parameter bands and seed factors for a State of Residence parameter;

FIG. 9 is a table listing exemplary parameter bands and seed factors for a Days to Departure parameter;

FIG. 10 is a table listing exemplary parameter bands and seed factors for a Departure Month parameter;

FIG. 11 is a table listing exemplary data pertaining to an exemplary Trip Cancellation Benefit;

FIG. 12 is a table listing exemplary data to an exemplary Medical Benefit;

FIG. 13 is a table listing exemplary data for Base Coverages;

FIG. 14 is a table listing exemplary data for Custom, Optional, or Upgrade Coverages;

FIGS. 15-19 are exemplary user interfaces that a business or consumer may access to obtain a detailed insurance rate quote.

### DETAILED DESCRIPTION OF EMBODIMENTS OF THE INVENTION

Embodiments of the present invention provide a method and system to offer insurance at competitive rates and custom coverage packages. Embodiments of the present invention use multi-factor based pricing and a recursive underwriting procedure to determine the insurance rates and custom coverage packages. The inventive method and system may be applied to a variety of insurance products, including particularly travel insurance. Although the following description explains various features of the invention as related to travel insurance, persons of skill in the art will appreciate that the described underwriting methodology and systems may be applied to other types of insurance.

From an actuarial perspective, factor based pricing permits an insurance product to be rated through the use of multiple factors, each evaluated simultaneously with all other parameters. This underwriting approach differs from others that do not evaluate the effect of one parameter on another. The final determination of rates is through the calculation of factor relativities that are determined through an innovative recursive and simultaneous evaluation process.

The factors for each parameter are determined for each coverage within a travel insurance package. Factor relativities are derived from a minimum bias approach to apply on a multiplicative basis to generate an appropriate price for the insurance package. Each coverage has a base premium, and depending on the characteristics of the insured, factors relating to those characteristics are multiplied successively against the base premium. The factors are called “relativities” because they generally relate to the proportional differences between a predetermined set of individual characteristics and the selected set.

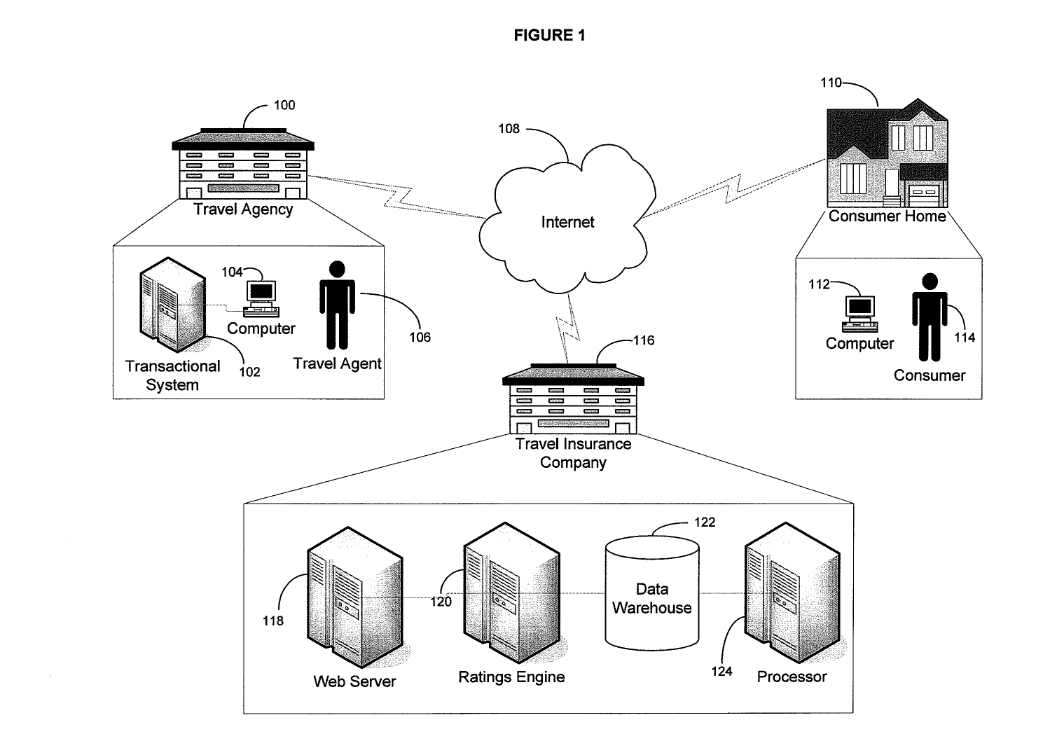

FIG. 1 illustrates a general architectural overview of a system useful to implement and/or use aspects of the invention. A travel insurance company 116 may offer a consumer 114 the opportunity to purchase travel insurance across the Internet 108. The consumer may access the travel insurance company's website to purchase any of several insurance products. Further, a travel insurance company 116 may allow a travel agency 100 to offer insurance products to a consumer. The travel agent 106 may use a web user interface to offer travel insurance products to its customers. However, the travel agent 106 may also use a transactional system 102 that incorporates a thin client application to purchase insurance products for consumers from the travel insurance company.

The travel insurance company 116 implements a web server 118 that gathers consumer information and displays different insurance products and rates through the travel insurance company's website. A processor 124 calculates the factor relativities using a minimum bias approach. A data warehouse 122, which may be a collection of databases, stores high quality actuarial and insurance data that is used to determine factor relativities. A ratings engine 120 accesses the calculated factor relativities from the data warehouse 122 to thereafter calculate a rate of an insurance product requested by a consumer 114 or travel agent 106.

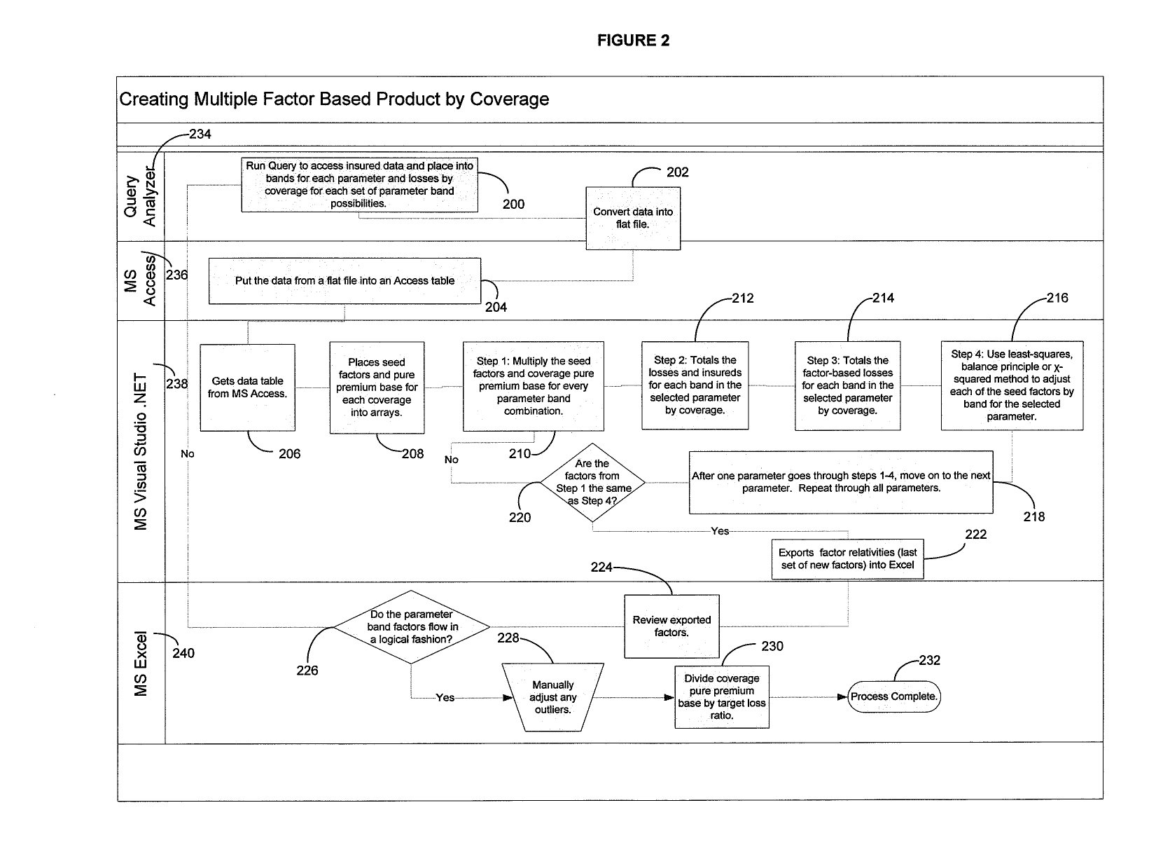

FIG. 2 generally illustrates the underwriting methodology useful in determining factor based pricing using a minimum bias approach. Software implementing the steps of the flow diagram may be contained within a processor 124 and data warehouse 122 within the travel insurance company (FIG. 1). This software may include, but is not limited to, a query analyzer 234, a database engine 236 (e.g. Access, SQL), data processing application 238 (e.g., implemented on Microsoft Visual Studio .NET), and a spreadsheet 240 (e.g. Microsoft Excel).

At step 200, a query analyzer queries a database to access insured data. The analyzer organizes the data into bands for each parameter and losses by coverage for each set of parameter band possibilities. The query analyzer thereafter converts the data into a flat file, step 204, to permit the data to be transferred into a smaller database, step 204, for further analysis. The step of transferring data extracted from a larger database into a smaller one facilitates faster analysis of the extracted data. In the preferred embodiment illustrated in FIG. 2, the first database is a SQL Server database and the second database is a Microsoft Access database.

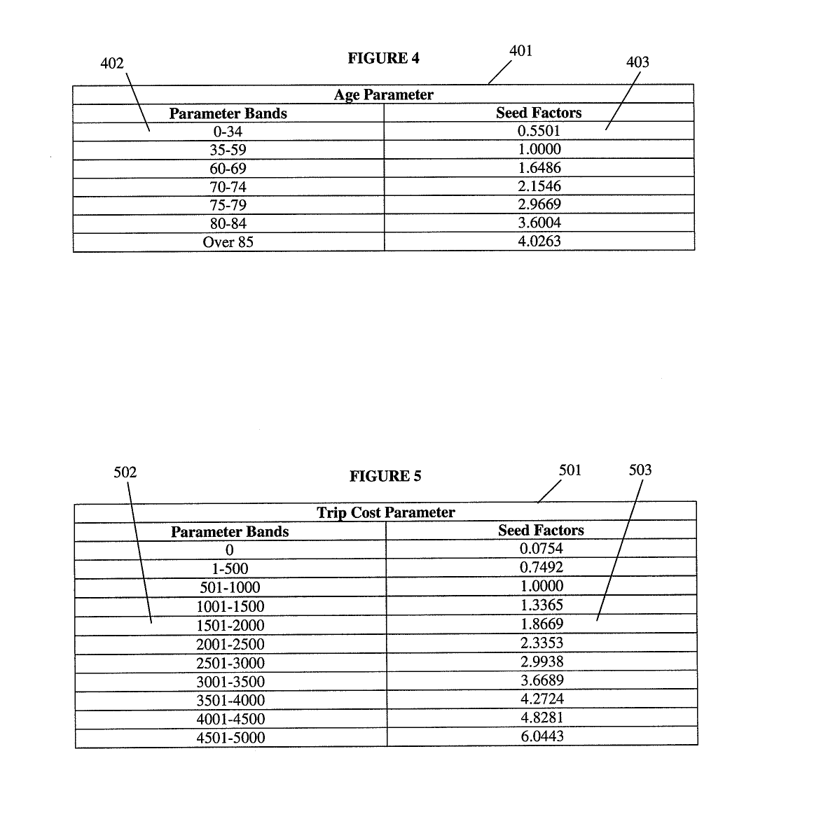

At step 206, an application 238 accesses the data table from the Access database 236. The application 238 places seed factors and a pure premium base for each coverage for all parameter bands into arrays, step 208. Seed factors are the initial inputs used to produce the final factor relativities that, when applied to a base premium rate, are used to calculate a final insurance rate. The seed factors are determined by evaluating the insurance package results stored in the data warehouse 122 for each parameter. The pure premiums (loss costs) are calculated for each of the exemplary bands above. A certain band (e.g. the most populous band) is defined as the base band and all remaining bands are divided by this band's loss cost. The base band is therefore set to 1.000 and other bands are stated relative to the base band. The base premium amount is adjusted in the opposite fashion to counteract the impact of subsequent adjustments. Exemplary seed factors for certain parameters are shown in FIGS. 4-10.

Seed factors are not the final factors because each seed factor is determined without regard to how each rating band is impacted by other factors. The seed factors are a reasonable starting point for a series of recursive calculations that incrementally adjust the factor. Through this iterative process, the factor converges on a value that accurately reflects the expected and isolated loss associated with the factor. Seed factors typically contain considerable cross bias when compared with the final factor relativities derived from the minimum bias procedure. The factor relativities demonstrate that the relationship by coverage with each parameter varies more than the seed factors. Determination of final factors through a recursive bias elimination process enables a more accurate rating, particularly as different coverage limits are proposed, than conventional approaches to travel insurance underwriting.

Steps 210 through 216 of FIG. 2 reflect an iterative process, whereby the initial seed factor is adjusted. At step 210, application 238 multiplies the seed factors and coverage pure premium base for every parameter band combination. The results are referred to as factor based losses. Application 238 thereafter totals the losses and insureds for each band in the selected parameter by coverage, step 212. At step 214, application 238 totals the factor-based losses for each band in the selected parameter by coverage. Application 238 then uses a minimizing formula to adjust each of the seed factors by band for the selected parameter, step 216. The resulting factors are referred to as new factors. A minimizing formula may be a least squares, balance principle, or %-squared method. As indicated in box 218 of the diagram, application 238 implements steps 210, 212, 214, and 216 on each parameter. At step 220, the programming platform 238 compares the initial factors with the adjusted factors. If the initial factor differs from the iteratively adjusted factor by more than a predetermined threshold (e.g. greater than 0.0001), application 238 will again iteratively adjust the factor. However, if the adjustment between the initial and adjusted factor is less than the predetermined threshold, the adjusted factor will be determined as the final factor.

At step 222, application 238 exports the factors into a spreadsheet 240. At step 224, the factor relativities are reviewed. Decisional 226 indicates that if the parameter band factors do not logically relate to actual loss experience, the process must start anew. However, if the parameter band factors are logically related to actual loss experience, the factor relativities will be manually adjusted, as needed, to account for outliers, step 228. Next, at step 230, the coverage pure premium base is divided by the target loss ratio to obtain a final rate factor.

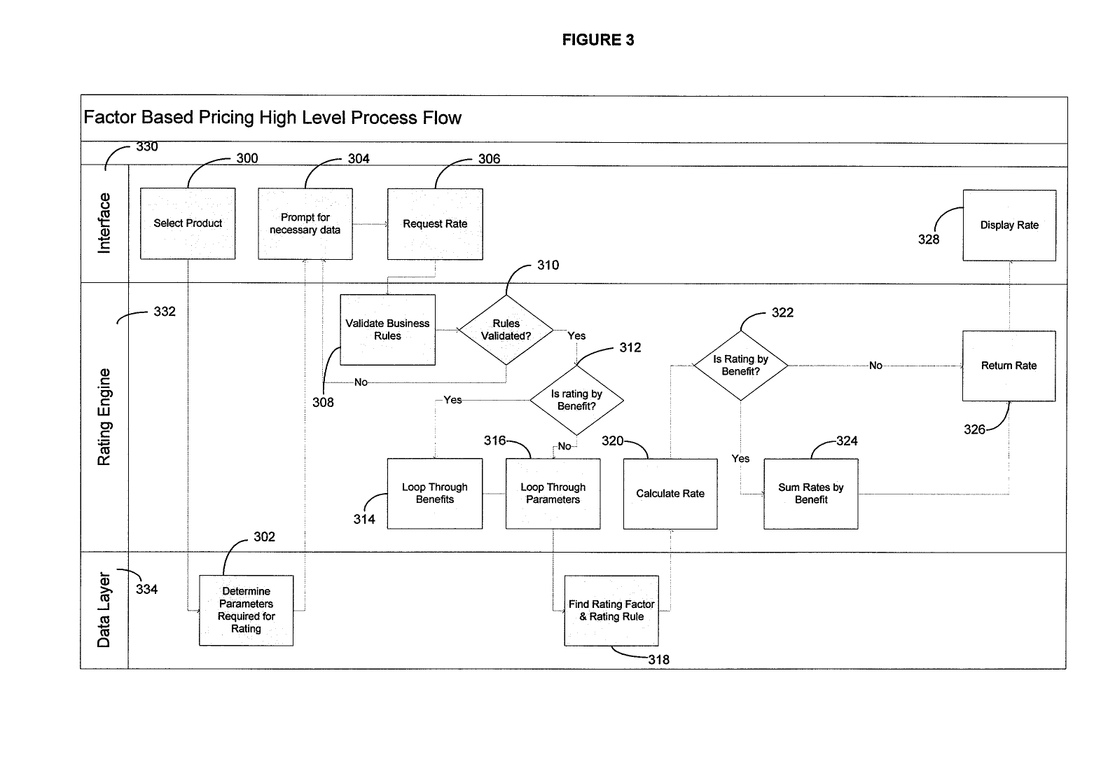

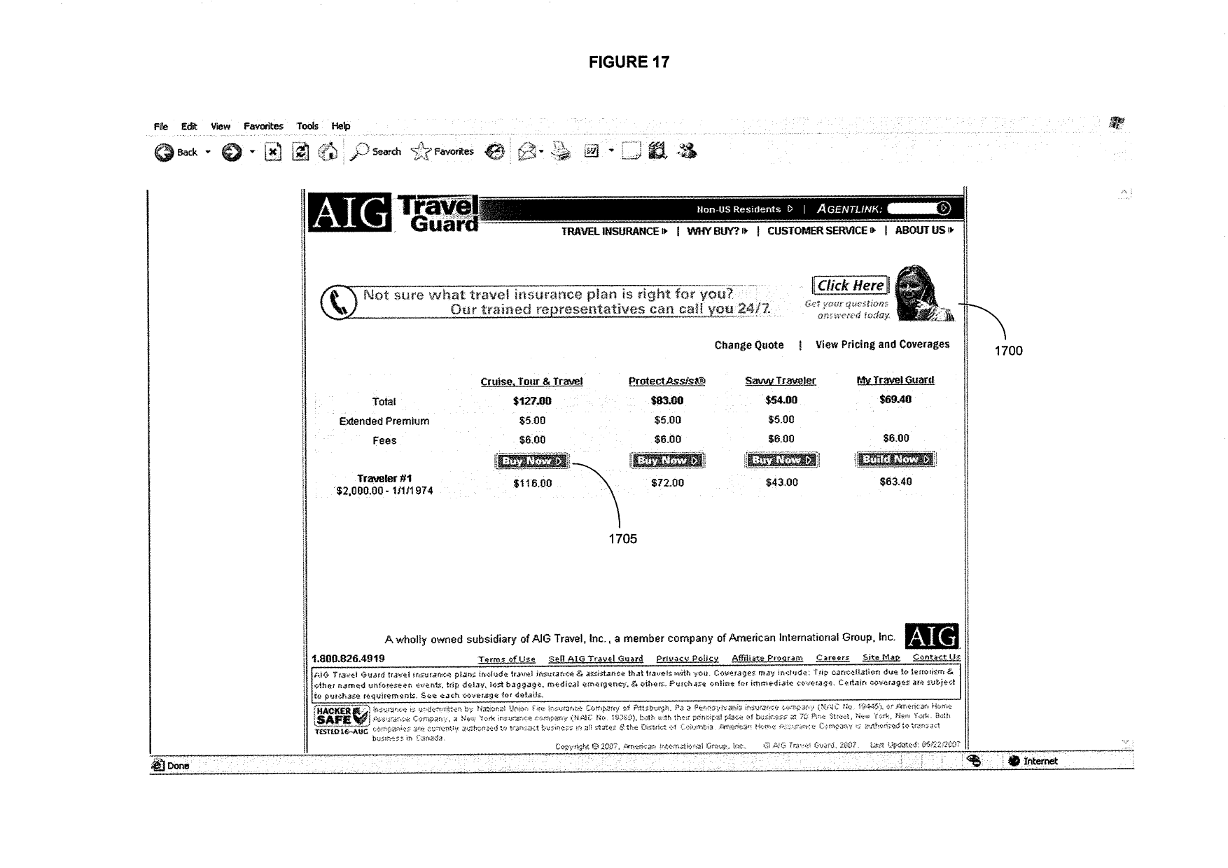

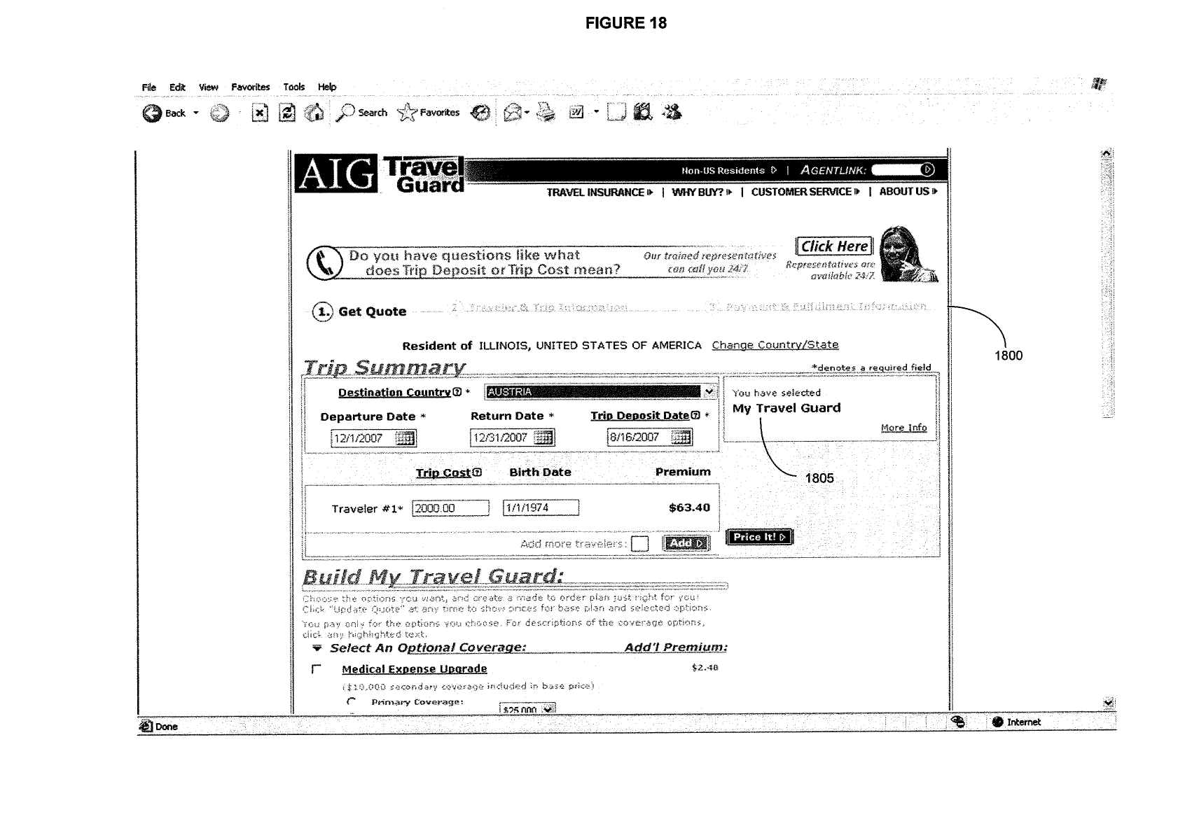

FIG. 3 is a flow diagram illustrating an exemplary method of a factor based pricing high level process. Exemplary system components include an interface 330 (e.g. web, XMLC, EZTips, or back office application), ratings engine 332, and data layer 334. As indicated at step 300, a consumer or travel agent selects an insurance product through a user interface. Examples of an insurance product are illustrated in FIGS. 13-14. The system thereafter determines the parameters required for rating the product, step 302, and a user interface prompts the consumer or travel agent for the necessary data to rate the product, step 304. The needed data may include all or a subset of the parameters listed in FIGS. 4-10, namely Age, Trip Cost, Trip Length, Destination, State of Residence, Days to Departure, Departure Month, and Trip Type (e.g. Air Only, Cruise, Tour, other).

At step 306, a consumer or travel agent requests the rate of the product. This request may be automatically prompted by the travel agent program or by an independent and manual process. At a next step 308, the ratings engine validates business rules on the entered data. The ratings engine thereafter determines whether the business rules are validated, step 310. An example of consumer data invalidating a business rule may be entering a destination that has no parameter band or entering an invalid Trip Type. If any of the consumer data violates a business rule, then the user interface prompts the consumer or travel agent to re-enter the data 304. However, if the business rules are validated, then the ratings engine determines whether the rating is by benefit. If so, then the ratings engine continues to a next step 314. If not, then the ratings engine continues to a next stage 316.

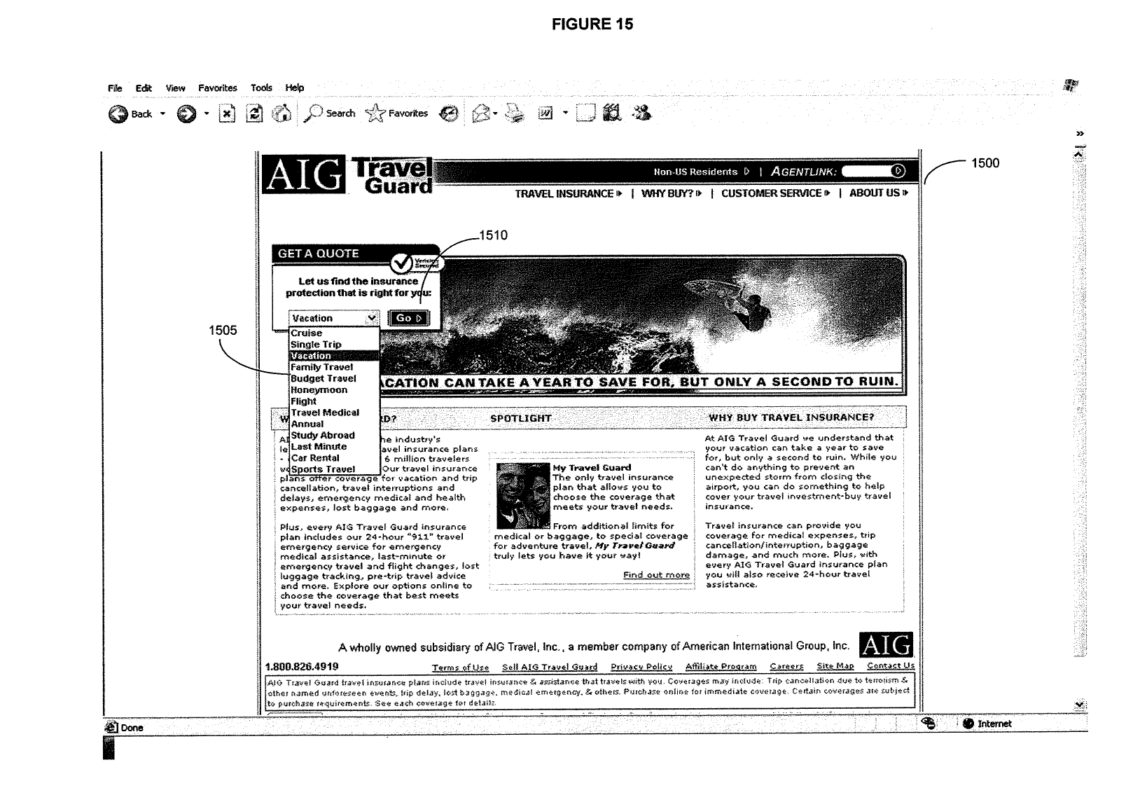

At step 314, the ratings engine accesses the benefits from a SQL database server. Exemplary lists of benefits are shown in FIGS. 13-14. Benefits may include, but are not limited to, Trip Cancellation Insurance, Trip Interruption Insurance, Medical Coverage, Evacuation Assistance, and Baggage Delay. The ratings engine accesses the parameters for each benefit from a SQL database, step 316. An example is shown in FIG. 11 that lists the parameter bands and the associated factor relativities for the age, trip length, and destination parameters for a Trip Cancellation Benefit. Accessing the benefit and parameter data from a SQL database in this fashion allows the highly efficient calculation of a rate.

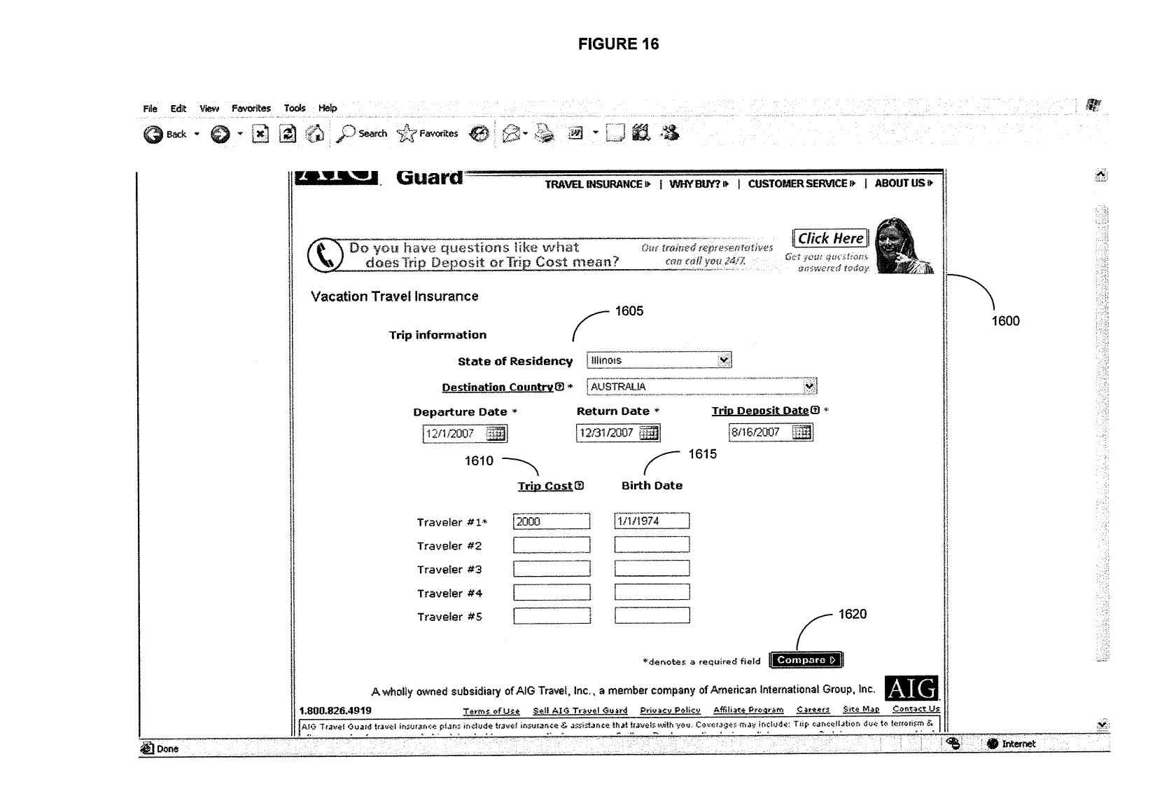

At a next step 318, a ratings engine finds the rating factor and rating rule. The rating factor may be the premium base rates as shown in FIGS. 11-12. An exemplary rating rule may be that for each day a consumer rents a car, collision damage waiver may cost $9 per day. The ratings engine thereafter calculates the rate, step 320. The ratings engine thereafter determines whether the rating is by benefit, decisional 322. If not, the ratings engine continues to step 326 to return the rate. If so, the ratings engine calculates the final rates by benefit, step 324. After the ratings engine returns the rate, step 326, the user interface displays the rate to the application making the request, step 328.

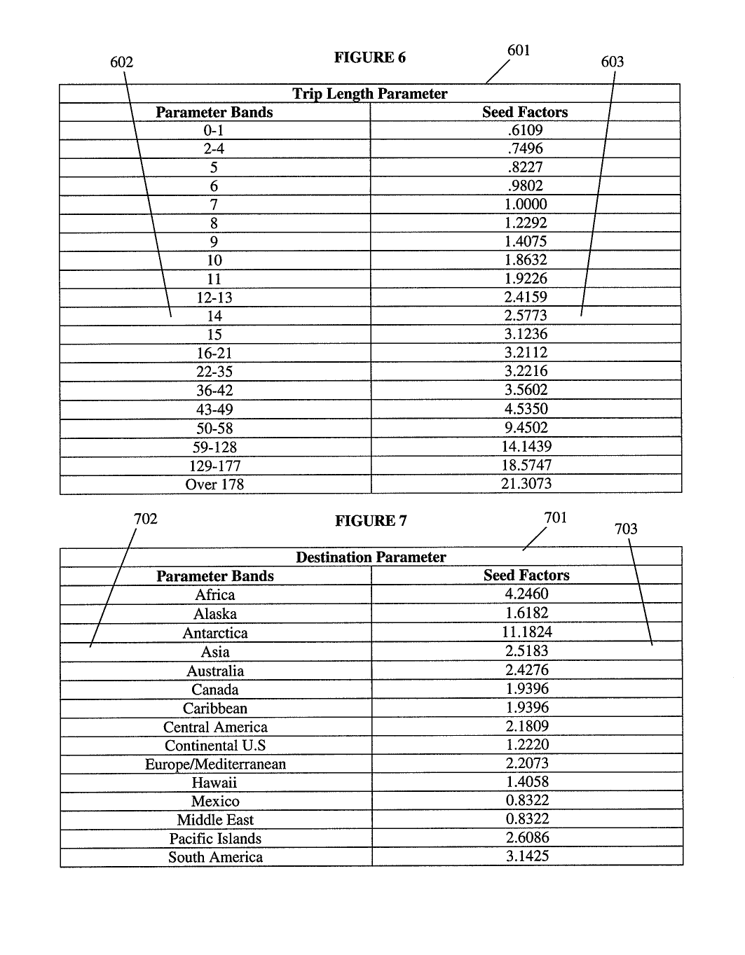

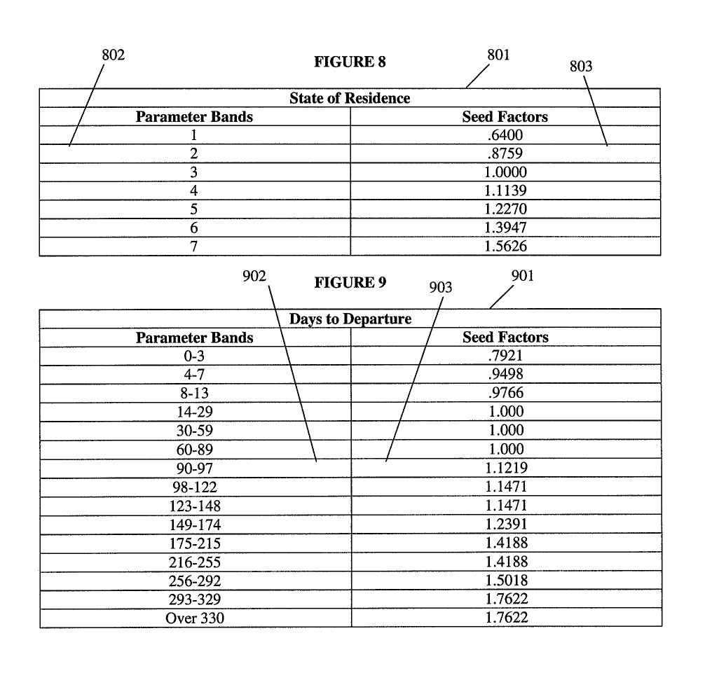

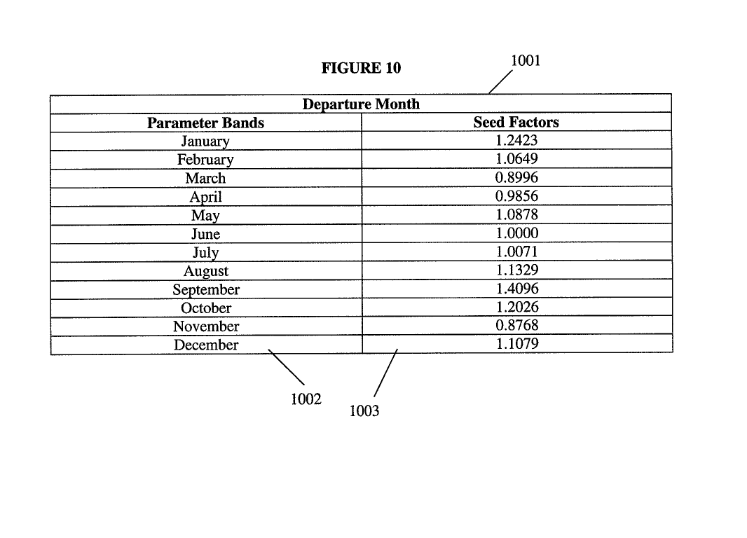

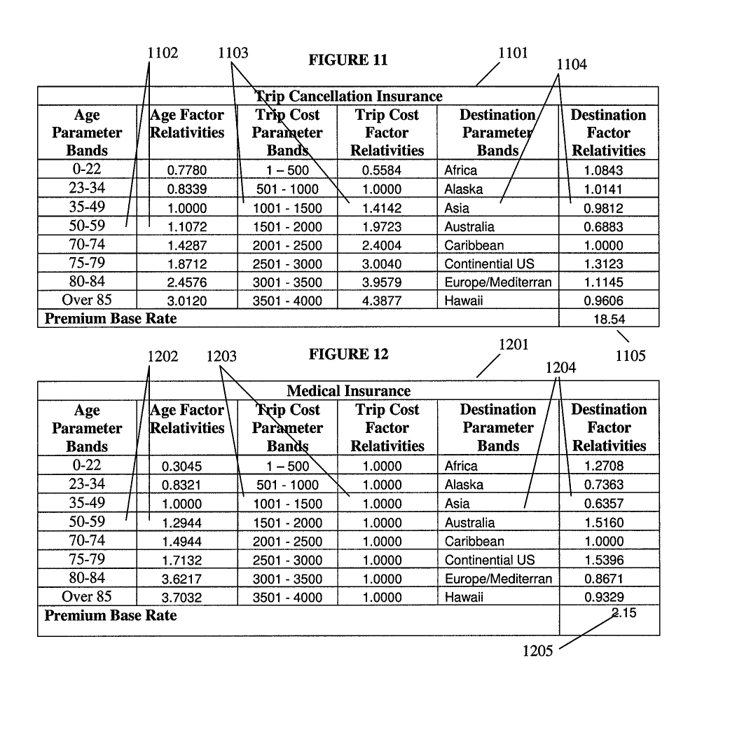

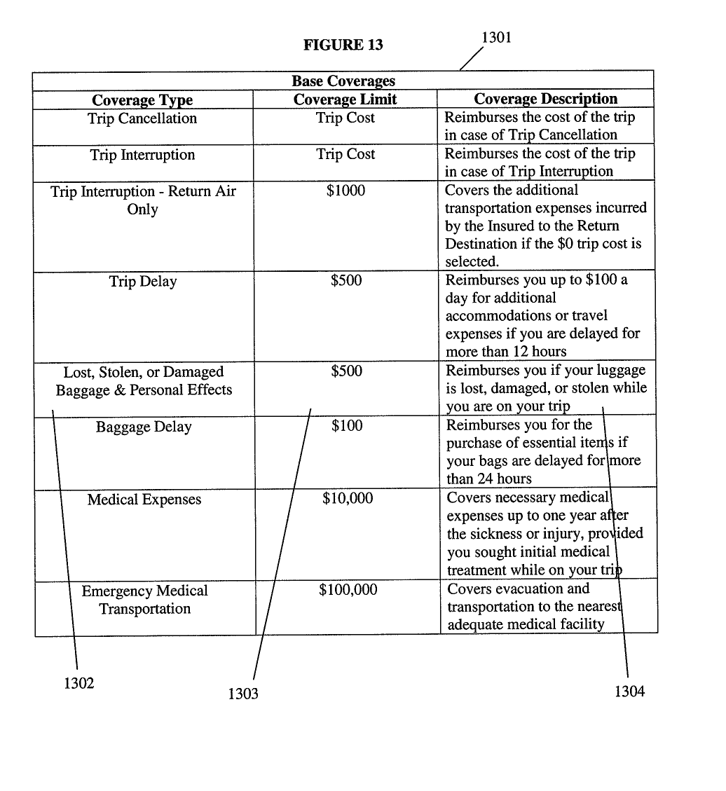

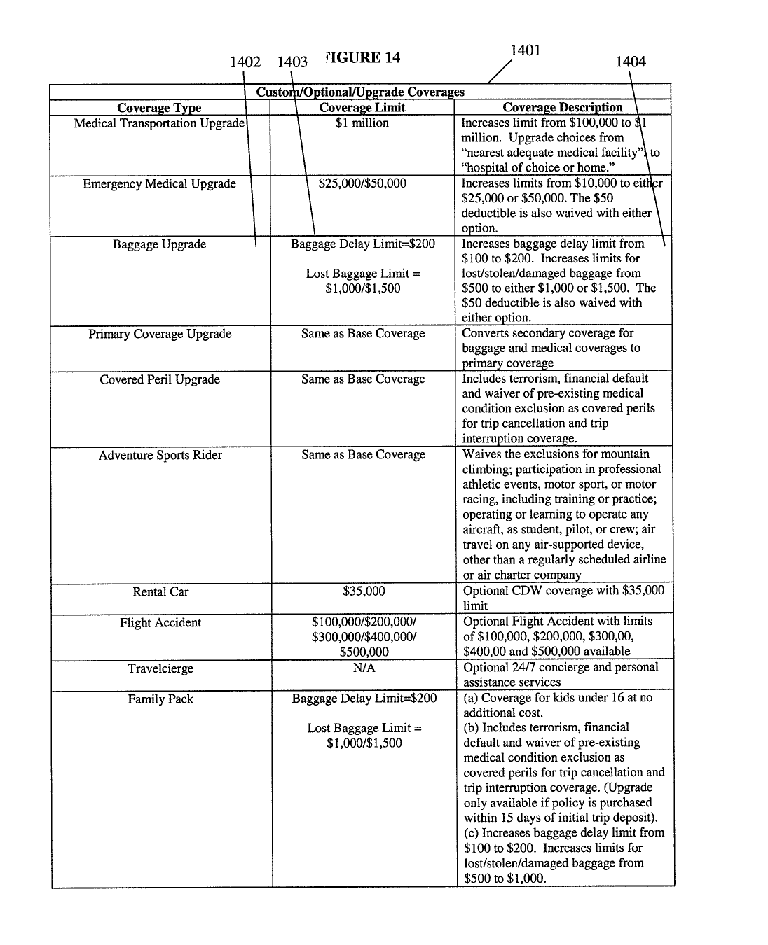

FIGS. 4-10 provide an exemplary list of data for parameters that includes their parameter bands and seed factors. Parameters may include, but are not limited to, Age, Trip Cost, Trip Length, Destination, State of Residence, Days to Departure Date, and Departure Month, and Trip Type (e.g. Air Only, Cruise, Tour, other). Each parameter may be associated with bands that are used in calculating coverage for individual consumers. Exemplary parameter bands are shown in FIGS. 4-10. For example, in FIG. 4 (401), the parameter band for age 0-34 years (402) contains a seed factor of 0.5501 (403). In FIG. 5 (501), the Trip Cost parameter band $1,501-$2,000 (502) contains a seed factor of 1.8669 (503). In FIG. 6 (601), the Trip Length parameter band of 14 days (602) contains a value of 2.5773 (603). In FIG. 7 (701), the destination parameter band for Asia (702) contains a seed factor of 2.5183 (703). In FIG. 8 (801) each parameter band represents a state. A parameter band 2 (802) contains a seed factor of 0.8759. In FIG. 9 (901), the Days to Departure parameter band 90-97 days (902) contains a seed factor of 1.1219 (903). In FIG. 10 (1001), the Departure Month December parameter band (1002) contains a seed factor of 1.1079 (1003).

A factor based pricing model using the minimum-bias procedure (where FIG. 2 is an example) translates a complex mathematical minimum bias procedure into a useful process that may be implemented on a computer. Embodiments of the invention use a combination of matrices and arrays. The matrices hold the demographics information of the insureds and the losses by coverage for those insureds. The arrays hold the coverage pure premium base and the factors calculated by the iterations of the minimum-bias procedure. A matrix allows the multiple dimensions to be represented in a two-dimensional form, while still holding the data needed for the calculation. The program then reduces the matrix into one-dimension as it evaluates each parameter by coverage. After the factor adjustment computation using a least-squares, balance principle or χ-squared methods, the program stores the new factors in multiple arrays.

Not all coverages are affected by the parameter selections in the same way. Embodiments of the invention incorporate separate parameters for each coverage by the parameter bands providing a more accurate rating and greater flexibility in adding additional coverage specific upgrades to the product. This approach also allows for easier adjustment of benefit levels of the coverages. Embodiments of the invention contain additional programming to adjust for simultaneous evaluation of factors on multiple coverages. Additional arrays are added to the calculation program as well as adding more columns to the matrices. Also, the factor adjustment computation part of the program is altered to accommodate multiple coverages. Embodiments of the invention implement this by adding additional columns (two for each coverage) to the one-dimensional parameter specific matrix. The first set of columns for each coverage holds the actual losses. The second set of columns holds the calculated losses using the coverage pure premium base on the currently stored factors in the multiple arrays (if this is the first iteration then the arrays hold the seed factors).

The following example uses the data in FIGS. 11-12, in which a consumer selects an insurance package that provides a Trip Cancellation Insurance Benefit (1101) and a Medical Insurance Benefit (1201). Both of these benefits require the same three parameters, namely age, trip cost, and destination. The user interface prompts the consumer for the necessary data, namely, the age of the consumer, the length of the consumer's trip, and the consumer trip destination. For example, the consumer may be 50 years of age (1102), with a trip cost of $1500 (1103), and a trip destination of Asia (1104). After validating business rules, the ratings engine accesses the factor relativities for each parameter for each benefit. For example, the ratings engine may first access the factor relativities for the Trip Cancellation Insurance Benefit. In such a case, the factor relativities for age, trip cost, and trip destination would be 1.1072, 1.412, and 0.9812, respectively. The ratings engine may then find the rating factor and rating rule for the benefit. In this case the rating factor may be the Premium Base Rate which equals $18.54 (1105). Then the ratings engine calculates the rate for the Trip Cancellation Insurance benefit as the product of the factor relativities and the premium base rate (1.1072×1.412×0.9812×$18.54) which equals a rate of $28.44. The ratings engine then calculates the rate of the next benefit (e.g. Medical Insurance). In such a case, the factor relativities for age (1202), trip cost (1203), and trip destination (1204) would be 1.2944, 1.0, and 0.6357, respectively. The ratings factor would be the premium base rate which equals $2.15 (1205). Multiplying the factor relativities with the Premium Base Rate yields a rate of $1.77. The ratings engine then adds the rates of each benefit together to yield a total rate of $30.21 which it returns and displays it to the consumer. [00381 In addition to providing rates for base coverages, embodiments of the invention permit a consumer to add or upgrade insurance coverage to create a custom insurance policy. This allows insurance carriers to offer a wide flexibility in the type of product consumers may purchase without introducing new products constantly. Insurance carriers can simply add new insurance coverages as optional packages.

There are several examples of optional insurance coverages. The minimum bias approach allows embodiments of the invention to offer rates on optional packages by the same or different relativity factors, as necessary, and track the premium separately by coverage. FIG. 13 (1301) displays an exemplary list of Base Coverages while FIG. 14 (1401) displays an exemplary list of custom, optional, or upgrade coverages for a consumer to purchase in addition to the base coverages. For example, a consumer may purchase the lost baggage and the baggage delay base coverages. The lost baggage base coverage (1302) provides a coverage limit of $500, and baggage delay base coverage provides a coverage limit of $100 (1303 and 1304) (See FIG. 13). However, a consumer may want to upgrade these coverages by purchasing the Baggage Upgrade coverage (1402) listed in FIG. 14. This would increase the coverage limit for lost baggage from $500 to either $1,000 or $1,500, and increase the coverage limit for baggage delay from $100 to $200 (1403 and 1404).

The minimum bias approach as illustrated in FIG. 2 computes the factor relativities for each custom, optional, and upgrade package in conjunction with its base coverage. Consequently, when a consumer chooses an upgrade coverage from a base coverage, embodiments of the invention perform the exemplary method illustrated in FIG. 3 to calculate the rate of both the base coverage and optional package.

Optional packages may include increasing coverage limits on medical expenses and baggage, and also selecting medical coverage to be primary medical insurance from secondary medical insurance. These packages are considered together when calculating the factor relativities using the previously described underwriting methodologies. Thus, factor relativities are computed for each separate package for each option. Then the rate of the package is computed by the ratings engine.

Other optional packages may include Increased Evacuation, Bring Them Home, Added Perils, and Adventure Sports Rider. Added Perils is coverage for Default, Terrorism and Pre-Ex if purchased within 15 days of deposit is an option that is packaged together. As with other optional and upgrade coverages, the previously adjusted amounts are added, and applied to the appropriate coverages and rating factors.

Embodiments of the invention allow for the coverage and limits to be accessed and distributed in several ways. Consumers may purchase an insurance product from a website. A consumer's state of residence may limit the insurance products available them to only those coverages where the insurance product is approved. Further, consumers may also purchase the insurance product through a call center. In addition, travel agents are able to offer and sell insurance products to their clients via a website. Products may also be marketed through online aggregators.

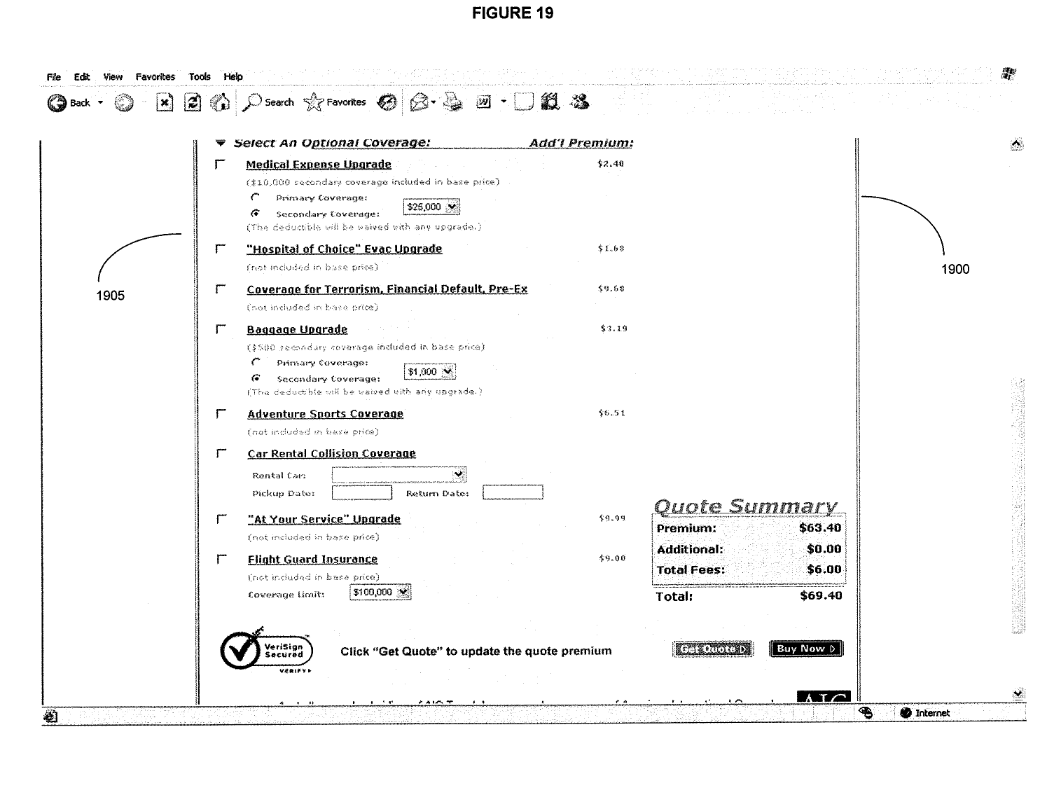

FIG. 15 is an exemplary user interface, in accordance to an embodiment of the invention. The user interfaces illustrated in FIGS. 15-19 are analogous to the interface 330 shown in FIG. 3. Further, there may be a ratings engine at a travel insurance company premises performing the software implementation shown in FIG. 3. FIG. 15 (1500) shows that a consumer may select insurance products for a variety of travel options that include, but are not limited to, Cruise, Single Trip, Vacation, Family Travel, Budget Travel, Honeymoon, Flight, Travel Medical, Annual, Study Abroad, Last minute, Car Rental, and Sports Travel (1505). Once a consumer chooses a travel options and selects the “Go” push button (1510), the user interface may display a web page as shown in FIG. 16.

FIG. 16 is an exemplary user interface, in accordance to an embodiment of the invention. FIG. 16 (1600) prompts the consumer for trip information that may include, but is not limited to, State of Residency, Destination Country, Departure Date, Return Date, Trip Deposit Date (1605), Trip Cost (1610) and Age (1615) of each traveler. After entering all the necessary information, a consumer may select the “Compare” push button (1620) to obtain an insurance rate. Selecting the “Compare” push button is analogous to requesting a rate in stage 306 of FIG. 3. Once the “Compare” push button is selected, the ratings engine shown in FIG. 3 may implement steps analogous to steps 308-326.

FIG. 17 is an exemplary user interface, in accordance to an embodiment of the invention. FIG. 17 (1700) displays the rates of several insurance products offered by a travel insurance company. After reviewing this web page a consumer may select to purchase any of these insurance products by selecting a “Buy Now” push button (1705). Selecting the “Buy Now” push button displays the web page shown in FIGS. 18-19.

FIGS. 18-19 are exemplary user interfaces, in accordance to an embodiment of the invention. FIG. 18 (1800) and FIG. 19 (1900) show the same web page. FIG. 18 displays the top portion of the web page, while FIG. 19 displays the bottom portion of the web page. FIGS. 18-19 allow the consumer to purchase custom, optional, or upgrade insurance coverages in addition to the base coverages of the insurance product. The ratings engine computes the rate for each custom, optional, or upgrade insurance product and displays it to the consumer (1805). Example of custom, optional, and upgrade insurance coverages are Medical Expense Upgrade, “Hospital of Choice” Evacuation Upgrade, Added Perils (Terrorism, Financial Default, and Pre-Ex) Coverage, Baggage Upgrade, Adventure Sports Coverage, Car Rental Collision Coverage, “At Your Service” Upgrade, and Flight Guard Insurance (1905). Once a consumer selects any additional coverages, if any, the consumer may then purchase the selected coverages by clicking the “Buy Now” push button.

The following example an exemplary method for the iterative steps 206-220 in FIG. 2 that finds the factor relativities, according to the above disclosure. The example finds the final factor relativities for Trip Cost and Age parameters that are used in calculating the rate for a Trip Cancellation and a Trip Interruption Benefit.

At an exemplary step 206, a software application accesses data, as shown in Table 1, from a database. The data in Table 1 contains the Actual Losses for a Trip Cancellation (TC) and a Trip Interruption (TI) benefit organized into Trip Cost and Age parameter bands.

TABLE 1
Actual Losses

| Trip Cost | Age | Insureds | TC Losses | TI Losses |
|---|---|---|---|---|
| 0-500 | 0-59 | 25 | 315.00 | 800.00 |
| 0-500 | 60-69 | 10 | 168.00 | 400.00 |
| 0-500 | 70+ | 5 | 117.60 | 270.00 |
| 501-1500 | 0-59 | 40 | 600.00 | 1,600.00 |
| 501-1500 | 60-69 | 20 | 400.00 | 1,000.00 |
| 501-1500 | 70+ | 10 | 280.00 | 675.00 |
| 1501-2500 | 0-59 | 35 | 656.25 | 1,792.00 |
| 1501-2500 | 60-69 | 20 | 500.00 | 1,280.00 |
| 1501-2500 | 70+ | 10 | 350.00 | 864.00 |
| 2501-3500 | 0-59 | 30 | 585.00 | 1,584.00 |
| 2501-3500 | 60-69 | 10 | 260.00 | 660.00 |
| 2501-3500 | 70+ | 5 | 182.00 | 445.50 |

As part of exemplary step 208, a software application calculates the Base Loss Costs for TC and TI. The Base Loss Cost for a benefit is calculated by dividing the sum of the losses for each parameter band for the benefit by the sum of the insureds. The TC Base Loss Cost and TI Base Loss Cost are shown in Table 2.

TABLE 2
Base Loss Cost

| | |
|---|---|
| TC | $20.06 |
| TI | $51.68 |

Also as part of exemplary step 208, seed factors are selected for the iterative procedure. Seed factors are not the final factors because each seed factor is determined without regard to how each rating band is impacted by other factors. As previously noted, the seed factors are a reasonable starting point for a series of recursive or iterative calculations that incrementally adjust the factor. The software application applies an iterative and recursive calculations to converge on a factor value that accurately reflects the expected and isolated loss associated with the factor. A software application implements the iterative procedure due the complexity and high number of calculations that are needed to be performed. The seed factors for this example are shown in Tables 3 and 4.

TABLE 3
Seed Factors for Trip Cost

| | TC | TI |
|---|---|---|
| 0-500 | 0.900 | 0.800 |
| 501-1500 | 1.000 | 1.000 |
| 1501-2500 | 1.100 | 1.150 |
| 2501-3500 | 1.200 | 1.300 |
| 0-59 | 0.750 | 0.800 |

TABLE 4
Seed Factors for Age

| | TC | TI |
|---|---|---|
| 60-69 | 1.000 | 1.000 |
| 70+ | 1.200 | 1.300 |

As part of the iterative procedure, any iterative minimizing procedure may be used to find the relative factors for a parameter. These include a Balance Principle, Least Squares, or Chi-Squared approach. The general form of each equation is shown as follows:

Balance Principle Equation=xᵢ=Σnᵢⱼrᵢⱼ/Σ . . . Σnᵢⱼyⱼ . . . zₖ,

Least Squares Equation: xᵢ=Σ . . . nᵢⱼ²rᵢⱼyⱼ . . . zₖ/Σ . . . Σnᵢⱼ²yⱼ² . . . zₖ²

Chi-Squared Equation: xᵢ={Σ . . . Σ[nᵢⱼrᵢⱼ²/(yⱼ . . . zₖ)]/Σ . . . Σnᵢⱼyⱼ . . . zₖ}^{0.5}

where xᵢ=Relative Factor for the Parameter, n=number of insureds, r=actual loss cost, y . . . z=Factors for each parameter y . . . z, and i, j, . . . k represent the number of bands for each factor x, y, . . . z, respectively.

In this example, the Balance Principle, Least Squares, and Chi-Squared formulas for the two parameters (Trip Cost and Age) are listed below:

Balance Principle Equation=xᵢ=Σnᵢⱼrᵢⱼ/nᵢⱼyⱼ,

Least Squares Equation: xᵢ=Σnᵢⱼ²rᵢⱼyⱼ/Σnᵢⱼ²yⱼ²

Chi-Squared Equation: xᵢ=[Σ(nᵢⱼrᵢⱼ²/yⱼ)/Σnᵢⱼyⱼ]^{0.5}

where x=Trip Cost Factors, n=insureds, r=actual loss cost, y=age factors, and i and j represent the number of bands for a trip cost factor and an age factor, respectively.

The final factor relativities for the Trip Cost and Age parameters can be found using the iterative procedure shown in the exemplary steps 210-220 in FIG. 2 and the data in Tables 1-4. Tables 5-7 show the final factor relativities using the Balance Principle, Least Squares, and Chi-Squared iterative procedures, respectively.

TABLE 5
Final Factors Using Balance Principle

| Loss Base: | | 20.06 | 51.68 |
|---|---|---|---|
| Trip Cost | Age | TC | TI |
| 0-500 | | 0.8635 | 0.7797 |
| 501-1500 | | 1.0280 | 0.9747 |
| 1501-2500 | | 1.2850 | 1.2476 |
| 2501-3500 | | 1.3363 | 1.2865 |
| | 0-59 | 0.7274 | 0.7941 |
| | 60-69 | 0.9699 | 0.9927 |
| | 70+ | 1.3579 | 1.3401 |

TABLE 6
Final Factors Using Least Squares Method

| Loss Base: | | 20.06 | 51.68 |
|---|---|---|---|
| Trip Cost | Age | TC | TI |
| 0-500 | | 0.8508 | 0.7770 |
| 501-1500 | | 1.0128 | 0.9713 |
| 1501-2500 | | 1.2660 | 1.2432 |
| 2501-3500 | | 1.3166 | 1.2821 |
| | 0-59 | 0.7383 | 0.7969 |
| | 60-69 | 0.9844 | 0.9961 |
| | 70+ | 1.3781 | 1.3448 |

TABLE 7
Final Factors Using Chi-Squared Method

| Loss Base: | 20.06 | 51.68 | | |
|---|---|---|---|---|
| Trip Cost | Age | | TC | TI |
| 0-500 | | | 0.8652 | 0.7798 |
| 501-1500 | | | 1.0300 | 0.9748 |
| 1501-2500 | | | 1.2875 | 1.2477 |
| 2501-3500 | | | 1.3390 | 1.2867 |
| | 0-59 | | 0.7260 | 0.7940 |
| | 60-69 | | 0.9680 | 0.9925 |
| | 70+ | | 1.3552 | 1.3399 |

The iterative procedure described above minimizes cross-biases between factors to accurately price insurance products with respect to loss. Pricing mechanisms used in the prior art for travel insurance products typically provide a loss ratio of 0.42. However, experience has shown rates found using the invention for the same travel insurance products to improve the loss ratio substantially, e.g., 0.31. The invention results in a 25% improvement, or more, over the prior art, thereby providing a more accurate pricing of insurance products.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for determining a rate of insurance, the steps comprising:
analyzing insured data to determine parameters and parameter bands needed for a plurality of insurance benefits;
storing parameter and parameter band data for the plurality of insurance benefits in a first database;
accessing parameter and parameter band data for the plurality of insurance benefits from the first database;
calculating with a computer seed factors based on parameter, parameter band, and premium base rate, for the plurality of insurance benefits;
calculating factor relativities using an iterative procedure from seed factors, for the plurality of insurance benefits; and
determining a rate of insurance by applying the calculated factor relativities to a selected insurance product.

2. The method according to claim 1, further comprising the step of providing rates for insurance benefits based on consumer preferences.

3. The method according to claim 1, further comprising the steps of extracting insured data from the first database; and storing the insured data into parameter bands as flat file in a second database.

4. The method according to claim 1, wherein the iterative procedure is selected from the group consisting of a Balance Principle equation, Least Squares Method equation, and Chi-Squared Method equation.

5. The method according to claim 1, wherein one or more software applications that are implemented by the computer and databases are selected from the group consisting of a query analyzer, database program, visual basic program, and a spreadsheet application.

6. The method according to claim 1, further comprising the steps of:
determining whether a first factor of a parameter in a first iteration is within a threshold of a second factor of the parameter in a second iteration;
designating the first factor as a final factor when the first factor in the first iteration is within the threshold of the second factor of the second iteration, wherein the final factor is used to calculate the rate of insurance;
performing another iteration of the iterative procedure when the first factor of the first iteration is not within the threshold of the second factor of the second iteration.

7. The method according to claim 1, wherein the insurance benefits are selected form the group consisting of Trip Cancellation Insurance, Trip Interruption Insurance, Medical Coverage, Evacuation Assistance, Baggage Delay, Increased Evacuation, Bring Them Home, Added Perils, and Adventure Sports Rider.

8. A method for determining a rate of insurance, the steps comprising:
computing the parameters needed to calculate an insurance rate for a selected insurance product;
requesting consumer information from a consumer to calculate the insurance rate;
validating consumer information based on business rules;
calculating, with a computer, the rate of the insurance product based on independently calculated factor relativities and a premium base rate for each insurance benefit of the insurance product; and
displaying the rate of the selected insurance product to the consumer.

9. The method according to claim 8, further comprising the steps of calculating the rate of each insurance benefit of the insurance product using an iterative procedure.

10. The method according to claim 8, wherein the iterative procedure is selected from the group consisting of a Balance Principle equation, Least Squares Method equation, and Chi-Squared Method equation.

11. The method according to claim 8, wherein one or more software applications that are implemented by the computer and databases are selected from the group consisting of a query analyzer, database program, visual basic program, and a spreadsheet application.

12. The method according to claim 8, wherein the parameters are selected from the group consisting of Age, Trip Cost, Trip Length, Destination, State of Residence, Days to Departure, Departure Month, and Trip Type.

13. The method according to claim 8, further comprising the step of determining a rating factor and rating rule for the rate of the insurance product.

14. A system for determining a rate of insurance, the components comprising of:
a user interface capable of permitting a consumer to request a rate of an insurance product from an insurance carrier;
a web server that displays insurance products, rate information, and other insurance data to a consumer;
a storage device containing independent factor relativities calculated using a minimum bias procedure;
a ratings engine that calculates the rates of insurance products using factor relativities.

15. The system according to claim 14, the components further comprising a software application that calculates the independent factor relativities.

16. The system according to claim 14, the components further comprising a calculation module that accesses the calculated independent factor relativities from the storage device to calculate the rate of the insurance product.

17. The system according to claim 14, the components further comprising of a first database that contains insured data to be used to calculate the rate of the insurance product;
a second database that contains a converted flat file of the insured data placed into parameter bands, to be used to calculate the rate of insurance.

18. The system according to claim 14, wherein the minimum bias procedure is selected from the group consisting of a Balance Principle equation, Least Squares Method equation, and the Chi-Squared Method equation.

19. The system according to claim 14, wherein one or more software applications that are implemented by the calculation module and the databases are selected from the group consisting of a query analyzer, database program, visual basic program, and a spreadsheet application.
